(19) United States
(12) Patent Application Publication
(10) Pub. No.: US 2005/0264150 A1
(43) Pub. Date: Dec. 1, 2005

(54) Short arc lamp

(75) Inventor: Yasuhiro Sawada, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA

(21) Appl. No.: 11/138,263

(22) Filed: May 27, 2005

(30) Foreign Application Priority Data
May 28, 2004 (JP) 2004-158739

(51) Int. Cl. H01J 5/16

(52) U.S. Cl. 313/113

(57) ABSTRACT

It is an object of the present invention to provide a short arc lamp capable of forming good electric discharge, by making the optical axis X of the lamp main body agree with the central axis of an anode. The short arc lamp having a lamp main body in which a concave portion having a reflective surface is formed, a cathode and an anode disposed in the concave portion to face each other, a cathode side power supply member connected to a conductive support which supports the cathode, and an anode side power supply member which supports the anode, wherein the anode side power supply member is made of material having coefficient of thermal expansion of less than 13.9×10⁻⁶ at 800° C. and joined to an end surface of the lamp main body by brazing.

### TECHNICAL FIELD OF THE INVENTION

The present invention relates to a reflective surface built-in short arc lamp, in which a reflective surface is formed on a lamp main body made of alumina, and xenon gas is enclosed in an electric discharge space as gas for emitting light, and specifically to a short arc lamp used as a back light etc. of an endoscope, a data projector and the like.

### DESCRIPTION OF RELATED ART

Conventionally, a reflective surface built-in short arc lamp is known, wherein a concave reflective surface is formed inside the lamp main body made of ceramic (for example, alumina) which is insulating material, and an opening of the reflective surface which is provided in a light emitting direction (a light taking out direction) is covered by light transmitting glass (such as transparent glass or translucent glass).

Such a short arc lamp can be miniaturized since it is not necessary to combine the lamp with a separate reflective mirror, and in addition, the lamp can be easily handled and is very strong since the lamp is shaped cylindrically. Furthermore, since there is almost no possibility of a burst, it is highly safe. In Japanese Laid Open Patent No. 11-1624112, such a short arc lamp is disclosed.

FIG. 3 is a cross sectional view taken along in a longitudinal direction of the conventional short arc lamp.

As shown in the figure, the short arc lamp 30 is equipped with a cylindrical lamp main body 31 made of alumina. In a concave portion 311 formed inside the lamp main body 31, a cathode 32 and an anode 33 which face each other are disposed, and a reflective surface 312 is formed on a surface of the concave portion 311. An anode side power supply member 34 is fixed to an end surface 313 of the lamp main body 31 by a first fixing member 35 which is cylindrical. The anode 33 is inserted in a through-hole provided in the center of the anode side power supply member 34, and is held thereto by brazing, wherein the tip of the anode 33 projects into the concave portion 311 from a center hole 314 provided on the end side of the lamp main body 31.

On the other hand, a ring-like cathode side power supply member 36 is fixed to an end surface 315 on a side of the opening of the lamp main body 31 by a second fixing member 37 which is cylindrical. The cathode 32 is welded to one end of the conductive support member 38, and the end of the conductive support member 38 is inserted in and fixed to a recess formed in the cathode side power supply member 36. Moreover, a window member 40 is inserted in and fixed to a central opening of a flange 39 connected to the cathode side power supply member 36.

In such a structure, the electric discharge space S defined by the concave portion 311 of the lamp main body 31, the anode 33, the anode side power supply member 34, the cathode side power supply member 36, the flange 39, and the optical extraction window 40 is formed. Electric discharge can take place between the cathode 32 and the anode 33 by turning on electricity to the first fixing member 35 and the second fixing member 37 so that the short arc lamp 30 having the above-mentioned structure can be turned on.

However, there are problems in such a short arc lamp as set forth below.

(1) The first fixing member 35 is attached to the lamp main body 31 by brazing so that a central axis and an optical axis X agree with each other. And to the first fixing member 35, the anode side power supply member 34 is inserted with pressure, so that the central axis of the first fixing member 35 and the central axis of the anode 33 agree with each other, thereby the lamp main body 31 and the anode side power supply member 34 are integrated with each other. The first fixing member 35 disposed on the outer circumference of the lamp main body 31 is attached to the lamp main body 31 by filling up brazing material in a gap formed between the fixing member 35 and the lamp main bodies 31. However, since the brazing material has a fluidity nature and is not solidified instantly, the brazing material is not uniformly filled in the gap. In the case, as shown in FIG. 4, the optical axis X and the central axis of the first fixing member 35 do not agree with each other. When, in such a manner described above, the anode side power supply member 34 is inserted with pressure, the optical axis X of the lamp main body 31 and the central axis of the anode 33 may not agree with each other, so that good electric discharge may not be formed.

(2) Even if the gap between the first fixing member 35 and the lamp main body 31 is uniformly filled up with brazing (brazing) material, there will be a possibility that the following problems may rise. After the above-mentioned anode side power supply member 34 is inserted into the first fixing member 35 which has been attached to the lamp main body 31, the first fixing member 35 and the anode side power supply member 34 are welded to each other. However, since this welding is performed to the first fixing member 35 by locally applying heat, distortion of the first fixing member 35 may be produced. Thus, similarly to the above problem, there is a problem that the center of the anode 33 may shift from the optical axis X of the lamp main body.

### SUMMARY OF THE INVENTION

In view of the above-mentioned problem, it is an object of the present invention to provide a short arc lamp capable of forming good electric discharge, by making the optical axis X of the lamp main body agree with the central axis of an anode.

The object of the present invention is accomplished by a short arc lamp having a lamp main body in which a concave portion having a reflective surface is formed, a cathode and an anode disposed in the concave portion so as to face each other at a predetermined interval at a predetermined position with respect to the reflective surface, a cathode side power supply member connected to a conductive support which supports the cathode, and an anode side power supply member which supports the anode, wherein the anode side power supply member is made of material having coefficient of thermal expansion of less than 13.9×10⁻⁶ at 800° C. and joined to an end surface of the lamp main body by brazing.

The anode side power supply member may be made of kover.

In the short arc lamp, an annular recess surrounding an outer circumference of the anode may be formed on a surface of the anode side power supply member which is joined to the end surface of the lamp main body and an annular slot surrounding the outer circumference of the anode may be formed in the recess.

The advantages of the present invention set forth below can be obtained.

Since in the short arc lamp having a lamp main body in which a concave portion having a reflective surface is formed, a cathode and an anode disposed in the concave portion so as to face each other at a predetermined interval at a predetermined position with respect to the reflective surface, a cathode side power supply member connected to a conductive support which supports the cathode, and an anode side power supply member which supports the anode, the anode side power supply member is made of material having coefficient of thermal expansion of less than 13.9×10⁻⁶ at 800° C. and joined to an end surface of the lamp main body by brazing, the optical axis X of the lamp main body and the central axis of the anode are made easily in agreement, and good electric discharge can be generated between the cathode and the anode.

If the anode side power supply member is made of kover, the anode side power supply member with easy forming nature and sufficient cutting nature can be obtained.

Since the annular recess surrounding an outer circumference of the anode is formed on a surface of the anode side power supply member which is joined to the end surface of the lamp main body and an annular slot surrounding the outer circumference of the anode is formed in the recess, whereby there is no possibility that the brazing material flows between the lamp main body and the anode side power supply member when a portion adjacent to the tip of the anode changes into a high temperature state at the time of lighting. Thus, it is possible to prevent a problem of contamination in the electric discharge space S, which is caused by evaporation of the brazing material that flows in near the anode.

### DESCRIPTION OF THE DRAWINGS

The present inventions will now be described by way of example with reference to the following Figures, in which:

FIG. 1 is a cross-sectional view of a short arc lamp according to the present invention, taken along a longitudinal direction thereof;

FIG. 2 is a table showing the result of the experiments using nine short arc lamps;

FIG. 3 is a cross sectional view taken along in a longitudinal direction of the conventional short arc lamp; and

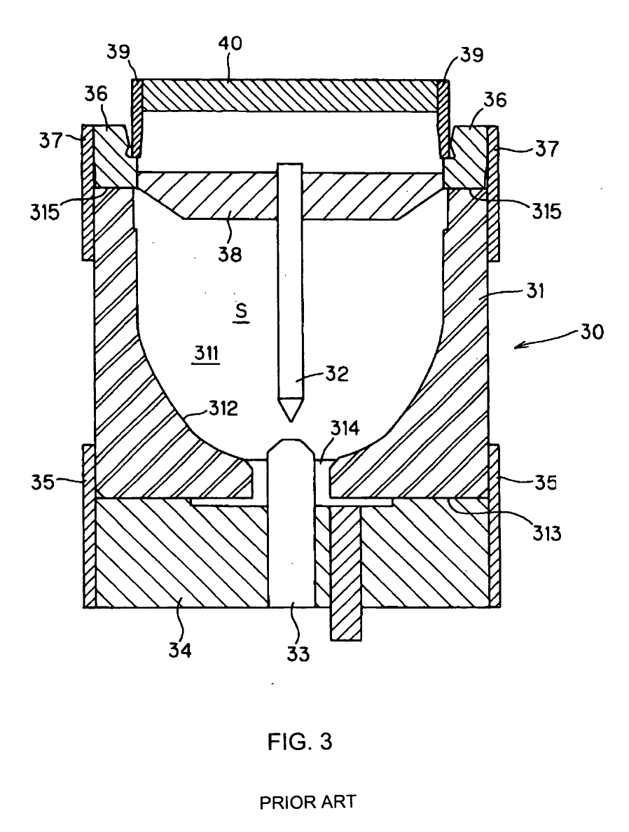

FIG. 3 is a cross sectional view thereof showing a problem of the conventional short arc lamp.

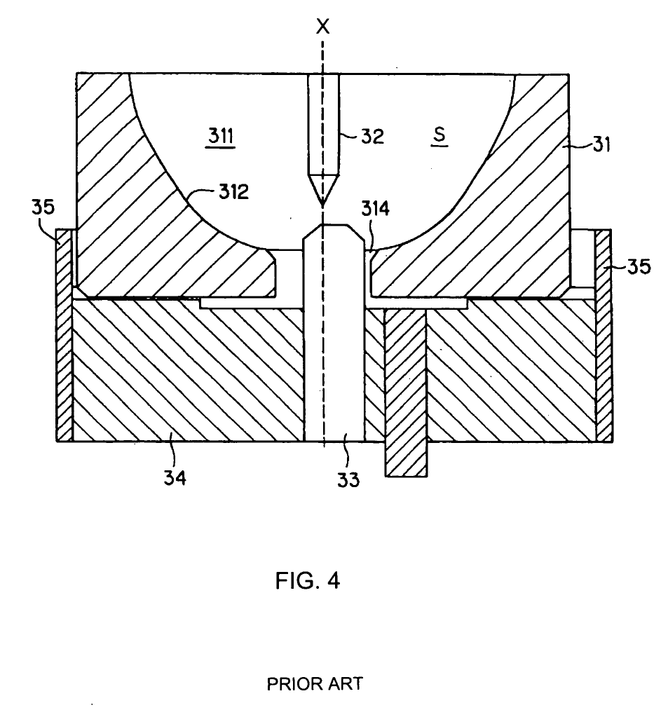

### DETAILED DESCRIPTION OF THE INVENTION

The present invention will become more apparent from the following detailed description of the embodiments and examples of the present invention. The following examples are given as a particular embodiment of the invention and to demonstrate the practice and advantages thereof. It is understood that the example is give by way of illustration and is not intended to limit the specification or the claims to follow in any manner.

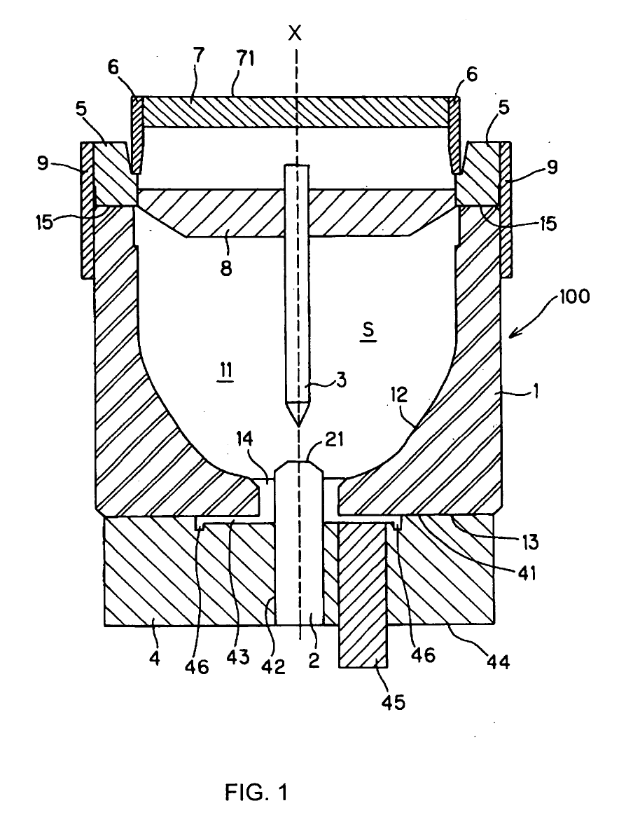

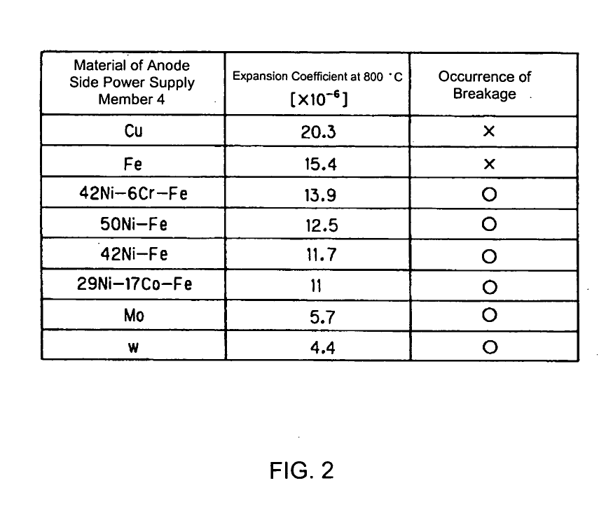

Description of the embodiment according to the present invention will be given below, referring to FIGS. 1 and 2.

FIG. 1 is a cross-sectional view of a short arc lamp according to the present invention, taken along a longitudinal direction thereof.

As shown in the figure, the short arc lamp 100 is equipped with a lamp main body 1 having a reflective mirror, and the lamp main body 1 is manufactured with alumina, wherein a concave portion 11 is formed inside the lamp main body 1, and the lamp main body 1 is shaped cylindrically. The outer diameter of the lamp main body 1 is 22 mm-70 mm, and the full length of the lamp main body 1 is 13 mm-75 mm. Metal, such as silver and aluminum etc., is deposited on the surface of the concave portion 11 so as to form a reflective surface 12. In a cross-sectional view, the reflective surface 12 has the shape of an ellipse or a parabola, etc. An anode 2 and a cathode 3 which are made of tungsten, are disposed in a concave portion 11 of the lamp main body 11, facing each other at interval of 0.5-2 mm distance so that they agree with the optical axis X, wherein the center thereof is located at a focal point of the lamp main body 1. The lamp main body 1 is joined to the block-shaped anode side power supply member 4 having approximately the same diameter as that of the lamp main body 1 by brazing.

Specifically, a metallizing processing by the molybdenum-mangan method is performed to an end surface 13 of the lamp main body 1, and the lamp main body 1 and the anode side power supply member 4 are joined by filling up with brazing material made of, for example, silver and copper between the end portion 13 and a front end surface 41 of the anode side power supply member 4.

The anode 2 is inserted in a through-hole 42 provided at the center of the anode side power supply member 4 and fixed by brazing, wherein the anode 2 is projected into the concave portion 11 from a central hole 14 formed on the side of the end portion 13 of the lamp main body 1.

The material of the metallized portion applied to the alumina of the end surface 13 of the lamp main body 1 is made of Mo—Mn and SiO₂, wherein the SiO₂ permeates unevenness of the surface of the alumina and the Mo—Mn is diffused in the SiO₂. Furthermore, nickel plating is carried out to this surface, thereby preventing oxidization of the Mo—Mn.

Moreover, although the anode side power supply member 4 is made of kover, nickel plating is given in order to prevent corrosion in the kover metal, by the brazing material which is used when attaching to the lamp main body 1 by brazing, and the oxidization of the kover.

The lamp main body 1 and the anode side power supply member 4 are attached to each other by brazing under approximately 800 degrees Celsius atmosphere, using very general brazing material made of silver and copper.

After brazing attachment, part of the Mo—Mn and SiO₂ of the metallized portion, and silver and copper of the brazing material, and each nickel plating are melted together so as to be diffused through SiO₂ as medium, thereby firmly joining the lamp main body 1 and the anode side power supply member 4.

Moreover, it is necessary to adjust temperature and dissolution time in accordance with brazing material to be used and tools for performing the brazing attachment by the brazing material. It is possible that the brazing material is moderately mixed with and diffused in the metallized portion by optimizing time for dissolution of the brazing material. When temperature is low, or the time is short, the brazing material produces residue of brazing material in the melting, so that it becomes impossible to form an airtight container. Moreover, when temperature is high, or when the time is too long, each of the components of the copper, and silver of the brazing material, the SiO₂ and the Mo—Mn of the metallized portion, and nickel of plating, dissociates according to the differences between the densities thereof, so that sufficient brazing attachment strength cannot be obtained.

Furthermore, an annular recess 43 surrounding the anode 2 is formed in a front end surface 41 of the anode side power supply member 4 on the side where the power supply member 4 is attached to the lamp main body 1 by brazing, and the through-hole 42 for receiving the anode 2 is formed at the center of the recess 43.

On the other hand, an exhaust pipe 45 for enclosing electric discharge gas, which is connected to the recess 43 is formed on a back end surface 44.

Furthermore, when the lamp main body 1 and the anode side power supply member 4 are attached to each other by brazing, in order to prevent the brazing material from flowing in near the anode 2, an annular slot 46 surrounding the perimeter of the anode 2 is formed in the recess 43 so that it may function as a brazing material reservoir. Two or more annular slots may be formed in the recess. This is because when the portion near the tip 21 of the anode 2 changes into a high temperature, there is no possibility that the brazing material flows in between the lamp main body 1 and the anode side power supply member 4 flows in near the anode 2 at the time of lighting, whereby contamination, in the electric discharge space S, caused by evaporation of the brazing material flowing in near the anode 2, can be prevented.

The anode side power supply member 4 is formed in the shape of a disk, wherein the outer diameter is 21 mm-70 mm, and the thickness thereof is 5 mm-25 mm.

Preferably, it is desirable for the anode side power supply member 4 to have sufficient heat capacity so that the brazing material for joining the anode 2 and the anode side power supply member 4, or the brazing material between the anode side power supply members 4 and the lamp main body 1 may not be melted by generation of heat at the time of lamp lighting, and the outer diameter of the anode side power supply member 4 is formed approximately equally to that of the lamp main body 1.

On the other hand, the ring-like cathode side electric supply heat material 5 is fixed to an end surface 15 which is located on the side of the opening of the lamp main body 1 by a cylindrical fixing member 9.

The cathode 3 is welded to one end of a conductive support member 8, and the other end of the conductive support member(s) 8 is inserted in and fixed to a slot formed in the cathode side power supply member 5. Moreover, a flange 6 made of ring-like kover is inserted in the inner surface of the cathode side power supply member 5. The disk-like optical extraction window 7 is inserted in the inner surface of the flange 6. The optical extraction window 7 is made of sapphire since the optical extraction window 7 is designed to transmit visible light, and high strength is required from the reason that high-pressure gas is enclosed in the electrical discharge space S. Coating with effects of, for example, decreasing reflection or an ultraviolet-rays cut etc., is applied to the surface 71 of the outside of the optical extraction window 7 if needed.

Moreover, by connecting the perimeter by three conductive support members 8, the cathode 3 is fixed so as to be arranged in a predetermined position. The conductive support members 8 are made of molybdenum, in which the width thereof is 2 mm-5 mm, and the thickness thereof is 0.3 mm-0.8 mm.

The cylindrical fixing member 9 is made of kover and is used for integratedly fixing the flange 6 fixed to the inner surface of the cathode side power supply member 5, the power supply member 5, and the optical extraction window 7, to the lamp main body 1, in which the fixing member 9 is arranged so as to cover the perimeter on the opening portion side of the lamp main body 1 and the cathode side power supply member 5.

By making up it in this manner, the electrical discharge space S approximately sealed by the combination of the concave portion 11 of the lamp main body 1, the anode 2, the anode side power supply member 4, the cathode side power supply member 5, the flange 6, and the optical extraction window 7 is formed in the interior of the short arc lamp 100.

Moreover, the fixing member 9 serves also as the electric supply mechanism for supplying electric power to the cathode 3 through the cathode side power supply member 5 and the conductive support member 8.

For example, xenon gas is enclosed through the gap connected with the electrical discharge space S between the end surface 13 of the lamp main body 1 and the recess 43, after air in the electrical discharge space S is discharged through an exhaust pipe 45 disposed in a back end surface 44 of the anode side power supply member 4. The xenon gas is enclosed so that the pressure at the time of enclosure is 15 kPa-30 kPa. And by turning on electricity to the anode side power supply member 4 and the fixing member 9, electric power is supplied to the anode 2 and the cathode 3, whereby dielectric breakdown is carried out between the anode 2 and the cathode 3 so that electric discharge takes place, whereby light which has the peak wavelength of approximately 450 nm in the visible region is emitted. As to the lighting conditions, for example the rated, current is 14 A, and power consumption is 175 W.

Thus, in the short arc lamp 100 according to the present invention, the lamp main body 1 and the anode side power supply member 4 can be integrated without using the fixing member like the conventional short arc lamp, and the above described problems (1) and (2) of the conventional short arc lamp resulting from the fixing member can be avoided.

Furthermore, the present inventor focused on the coefficient of thermal expansion of (the quality of) the material of the lamp main body 1, that of the anode side power supply member 4.

Since specifically it is common to use alumina as material which forms the lamp main body 1, it is found out that it is desirable to use material for the anode side power supply member 4, having coefficient of thermal expansion which is close to that of alumina. As a result, the coefficient of thermal expansion of the material used for the anode side power supply member 4 is defined to the proper range by experiments.

The reason for specifying the coefficient of thermal expansion is that since high pressure gas is enclosed in the short arc lamp according to the present invention, tensile stress is generated in the brazed portion of the lamp main body 1 and the anode side power supply member 4 in a direction in which they are pulled apart, and stress which is generated by brazing at 700 to 900 degrees Celsius at the time of manufacture is always applied to the joint. Since every time turning on and off the lamp is repeated, rise and decrease of temperature is repeated, so that thermal expansion and contraction is repeated, there is a possibility that the lamp main body 1 will be damaged, in case that there is a difference between coefficient of thermal expansion of the lamp main body 1 and that of the anode side power supply member 4, wherein the lamp main body 1 and the anode side power supply member 4 are integratedly provided. In addition, the coefficient of thermal expansion of the material which constitutes the anode side power supply member 4 according to the present invention is specified at 800° C. (degrees Celsius). This is because the melting point of the brazing material which is made of silver and copper generally used for joining ceramics and metal with each other is approximately 800° C. in general (between 800 degrees Celsius or a little above and 800 degrees Celsius or a little below).

Experiments which were carried out in order to define the coefficient of thermal expansion of the anode side power supply member 4 in the proper range will be described below.

The structure shown in FIG. 1 was used in the experiments, wherein each one of nine materials, copper (Cu), iron (Fe), 42Ni-6Cr—Fe, 50Ni—Fe, 42Ni—Fe, kover (Ni29-Co17-Fe), Alumina (Al₂O₃), molybdenum (Mo), and tungsten (W) was tested for the anode side power supply member 4 of the short arc lamp. The lamp main body 1 was made of alumina, and was 26 mm in outer diameter, and 20 mm in full length. The anode 2 was made of tungsten, and was 3 mm in maximum outer diameter and 15 mm in full length. The cathode 3 was made of thoriated tungsten wherein it had 50 degree taper angle at the tip thereof, and was 1.5 mm in maximum outer diameter and 15 mm in full length. The anode side power supply member 4 was 25 mm in outer diameter and 7 mm in thickness, wherein each one of the above nine material was used. The cathode side power supply member 5 was made of kover and was 26 mm in outer diameter, 21 mm in inner diameter, and 4 mm in thickness. The flange 6 was made of kover, and was 21.5 mm in outer diameter, 220 mm in inner diameter, and 7 mm in full length. The optical extraction window 7 was made of sapphire and was 20 mm in outer diameter, and 3 mm in thickness. The conductive support member 8 was made of molybdenum, and was 3 mm in width, and 0.4 mm in thickness. The fixing member 9 was made of kover, and was 27.5 mm in outer diameter, 26 mm in inner diameter, and 9 mm in full length.

FIG. 2 is a table showing the result of the experiments using the above nine short arc lamps, in which it was checked visually whether or not the lamp main body 1 was damaged after the short arc lamp was lighted for 100 hours at rated current of 14 A and rated power of 175 W.

In the table, “Expansion Coefficient at 800° C.” means the coefficient of thermal expansion of each material which forms the anode side power supply member 4. In the column of “Occurrence of Breakage”, “◯” means it was not damaged or broken, and “x” means it was damaged or broken. The coefficient of thermal expansion of the alumina which forms the lamp main body 1 was 7.9×10⁻⁶ at 800 degrees Celsius.

As shown in the table, when the coefficient of thermal expansion of the anode side power supply member 4 is within the range (less than 13.9×10⁻⁶ at 800° C. specified by the present invention, breakage of the lamp main body 1 does not take place. On the other hand, when the coefficient of thermal expansion of the materials such as copper (Cu) and iron (Fe) exceeds the range which is specified in the present invention, it turns out that breakage of the lamp main body 1 take place.

Since the coefficient of thermal expansion of copper (Cu) is fairly larger than alumina, tensile stress is generated in the alumina according to the difference of the expansion coefficients at the time of joining the alumina and the copper by brazing, thereby resulting in breakage.

Moreover, although in case of iron (Fe), breakage does not take place at the time of manufacturing, since the coefficient of thermal expansion is fairly large, large tensile stress is always applied to the alumina at the joint portion thereof. In addition, stress is repeatedly applied at the time of lighting, thereby resulting breakage. This breakage arises since the stress resulting from pressure applied between the alumina and the anode side power supply member increases according to internal gas pressure increased by heat generated at time of lighting, and strain is generated by stress caused by thermal expansion and contraction of each material. The series of breakage are attributed to the fact that the alumina which forms the lamp main body 1 is vulnerable to tensile stress. In addition, although breakage of the lamp main body 1 was not found, molybdenum (Mo) and tungsten (W) is hard to be processed, and is expensive. On the other hand, kover (Ni29-Co17-Fe) is excellent in cutting work nature, and is easy to be molded.

In addition, data of the case where the coefficient of thermal expansion of the material at 800 degrees Celsius which forms the anode side electric supply member 4 is less than 4.4×10⁻⁶ is omitted, since it is though that the lamp main body 1 is not damaged. This is because in case that the coefficient of thermal expansion becomes remarkably small as compared with the alumina which forms the lamp main body 1, although compressive power is applied to the lamp main body 1, the alumina is tough to the power of such compression.

Thus the present invention possesses a number of advantages or purposes, and there is no requirement that every claim directed to that invention be limited to encompass all of them.

The disclosure of Japanese Patent Application No. 2004-158739 filed on May 16, 2004 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A short arc lamp having a lamp main body in which a concave portion having a reflective surface is formed, a cathode and an anode disposed in the concave portion so as to face each other at a predetermined interval at a predetermined position with respect to the reflective surface, a cathode side power supply member connected to a conductive support which supports the cathode, and an anode side power supply member which supports the anode, wherein the anode side power supply member is made of material having coefficient of thermal expansion of less than 13.9×10⁻⁶ at 800° C. and joined to an end surface of the lamp main body by brazing.

2. The short arc lamp according to claim 1, the anode side power supply member is made of kover.

3. The short arc lamp according to claim 1, wherein an annular recess surrounding an outer circumference of the anode is formed on a surface of the anode side power supply member which is joined to the end surface of the lamp main body and an annular slot surrounding the outer circumference of the anode is formed in the recess.

4. The short arc lamp according to claim 2, wherein a annular recess surrounding an outer circumference of the anode is formed on a surface of the anode side power supply member which is joined to the end surface of the lamp main body and an annular slot surrounding the outer circumference of the anode is formed in the recess.

5. The short arc lamp according to claim 1, wherein the anode side power supply member has shape of a block.

6. A short arc lamp, comprising:
a lamp main body in which a concave portion is formed,
a cathode and an anode disposed in the concave portion so as to face each other,
an anode side member connected to the anode,
wherein the anode side member is made of material having coefficient of thermal expansion of less than 13.9×10⁻⁶ at 800° C. and joined to an end surface of the lamp main body by brazing.

7. The short arc lamp according to claim 6, wherein a recess surrounding the anode is formed in a front end surface of the anode side member.

8. The short arc lamp according to claim 7, wherein a central hole is formed in an end portion of the lamp main body.

9. The short arc lamp according to claim 8, wherein at least one slot is formed in the recess.

10. The short arc lamp according to claim 9, wherein the at least one slot is annular.

11. The short arc lamp according to claim 6, wherein electric power is supplied to the anode through the anode side member.

12. The short arc lamp according to claim 6, wherein the anode side member supports the anode.

13. The short arc lamp according to claim 6, further including a cathode side member.

14. The short arc lamp according to claim 13, wherein electric power is supplied to the cathode through the cathode side member.

15. The short arc lamp according to claim 14, wherein the cathode side member is connected to a conductive support which supports the cathode.

16. The short arc lamp according to claim 6, further including a window that covers an opening of the lamp main body.

17. The short arc lamp according to claim 16, wherein the window member is made of sapphire.

18. The short arc lamp according to claim 13, further including a fixing member, wherein the fixing member integratedly holds the cathode side member and the lamp main body.

19. The short arc lamp according to claim 18, the fixing member is made of molybdenum.
